(19) United States
(12) Patent Application Publication
(10) Pub. No.: US 2025/0080810 A1
(43) Pub. Date: Mar. 6, 2025

(54) INTERACTIVE SUPPLEMENTAL CONTENT PLATFORM

(71) Applicant: ROKU, INC., SAN JOSE, CA (US)

(72) Inventors: ROBERT L. LANDOWSKI, SAN JOSE, CA (US); EUNSUN MOTA CHOI, GILROY, CA (US); ALAYNA MARIE TRUTTMANN, SAN JOSE, CA (US); RYAN P. PRESSLER, NOVATO, CA (US); GREG MACK GARNER, KEY COLONY BEACH, FL (US)

(21) Appl. No.: 18/239,605

(22) Filed: Aug. 29, 2023

(51) Int. Cl. H04N 21/81; H04N 21/45; H04N 21/472; H04N 21/4784

(52) U.S. Cl. CPC H04N 21/8173; H04N 21/4532; H04N 21/472; H04N 21/4784; H04N 21/812

(57) ABSTRACT

Disclosed herein are system, apparatus, article of manufacture, method and/or computer program product embodiments, and/or combinations and sub-combinations thereof, for providing interactive supplemental content. An example embodiment operates by receiving a selection of an interactive media session in an application associated with a media device. In response to the receiving the selection, the embodiment generates the interactive media session. The interactive media session comprises interactive media content and interactive supplemental content. The embodiment then causes display, on a display device associated with the media device, the interactive media session. The embodiment then receives a user input to interact with the interactive supplemental content supplemental content in the interactive media session. The embodiment then, in response to receiving the user input, generates a reward in the interactive media session.

### TECHNICAL FIELD

This disclosure is generally directed to an interactive supplemental content platform, and more particularly to an application to provide interactive supplemental content such as, but not limited to, advertisements.

### SUMMARY

Provided herein are system, apparatus, article of manufacture, method and/or computer program product embodiments, and/or combinations and sub-combinations thereof, for providing interactive supplemental content such as, but not limited to, advertisements.

Certain embodiments operate by a computer-implemented method for providing interactive supplemental content. The method includes receiving, by at least one computer processor, a selection of an interactive media session in an application associated with a media device. The method further includes, in response to the receiving the selection, generating the interactive media session. The interactive media session comprises interactive media content and interactive supplemental content. The method further includes causing display, on a display device associated with the media device, the interactive media session. The method further includes receiving a user input to interact with the interactive supplemental content in the interactive media session. The method further includes in response to receiving the user input, generating a reward in the interactive media session.

In some aspects, the method further includes, prior to the receiving the selection of the interactive media session, causing display, on the display device associated with the media device, an indication to select the interactive media session in the application.

In some aspects, the interactive media content includes a character, the reward, or a display background associated with the interactive media session.

In some aspects, the generating the interactive media session includes identifying a characteristic of a user based on the selection of the interactive media session; and generating the interactive media content or the interactive supplemental content based on the characteristic of the user.

In some aspects, the interactive media content is associated with the interactive supplemental content based at least on contextual information.

In some aspects, the receiving the user input to interact with the interactive supplemental content in the interactive media session includes receiving the user input to interact with the interactive media content.

In some aspects, the receiving the user input to interact with the interactive supplemental content in the interactive media session includes receiving the user input from a remote control associated with the media device, and wherein the remote control comprises a, tablet, laptop computer, smartphone, smartwatch, smart device, or wearable device.

Other aspects are directed to a system that includes at least one processor configured to perform operations including receiving a selection of an interactive media session in an application associated with a media device. The operations further include in response to the receiving the selection, generating the interactive media session. The interactive media session comprises interactive media content and interactive supplemental content. The operations further include causing display, on a display device associated with the media device, the interactive media session. The operations further include receiving a user input to interact with the interactive supplemental content in the interactive media session. The operations further include in response to receiving the user input, generating a reward in the interactive media session.

In some aspects, the operations further include, prior to the receiving the selection of the interactive media session, causing display, on the display device associated with the media device, an indication to select the interactive media session in the application.

In some aspects, the interactive media content includes a character, the reward, or a display background associated with the interactive media session.

In some aspects, the operation of the generating the interactive media session includes identifying a characteristic of a user based on the selection of the interactive media session; and generating the interactive media content or the interactive supplemental content based on the characteristic of the user.

In some aspects, the interactive media content is associated with the interactive supplemental content based at least on contextual information.

In some aspects, the operation of the receiving the user input to interact with the interactive supplemental content in the interactive media session includes receiving the user input to interact with the interactive media content.

In some aspects, the operation of the receiving the user input to interact with the interactive supplemental content in the interactive media session includes receiving the user input from a remote control associated with the media device, and wherein the remote control comprises a, tablet, laptop computer, smartphone, smartwatch, smart device, or wearable device.

Further embodiments operate by a non-transitory computer-readable medium having instructions stored thereon that, when executed by at least one computing device, cause the at least one computing device perform operations that include receiving a selection of an interactive media session in an application associated with a media device. The operations further include, in response to the receiving the selection, generating the interactive media session. The interactive media session comprises interactive media content and interactive supplemental content. The operations further include causing display, on a display device associated with the media device, the interactive media session. The operations further include receiving a user input to interact with the interactive supplemental content in the interactive media session. The operations further include in response to receiving the user input, generating a reward in the interactive media session.

In some aspects, the operations further include, prior to the receiving the selection of the interactive media session, causing display, on the display device associated with the media device, an indication to select the interactive media session in the application.

In some aspects, the interactive media content includes a character, the reward, or a display background associated with the interactive media session.

In some aspects, the operation of the generating the interactive media session includes identifying a characteristic of a user based on the selection of the interactive media session; and generating the interactive media content or the interactive supplemental content based on the characteristic of the user.

In some aspects, the interactive media content is associated with the interactive supplemental content based at least on contextual information.

In some aspects, the operation of the receiving the user input to interact with the interactive supplemental content in the interactive media session includes receiving the user input to interact with the interactive media content.

In some aspects, the operation of the receiving the user input to interact with the interactive supplemental content in the interactive media session includes receiving the user input from a remote control associated with the media device, and wherein the remote control comprises a, tablet, laptop computer, smartphone, smartwatch, smart device, or wearable device.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a flowchart for a process for providing interactive supplemental content, according to some embodiments.

FIG. 4A illustrates a first example user interface for providing an interactive media session, according to some embodiments.

FIG. 4B illustrates a second example user interface of providing an interactive media session, according to some embodiments.

FIG. 4C illustrates a third example user interface of providing an interactive media session, according to some embodiments.

FIG. 4D is illustrates a fourth example user interface of providing an interactive media session, according to some embodiments.

FIG. 4E illustrates a fifth example user interface of providing an interactive media session, according to some embodiments.

FIG. 4F illustrates a sixth example user interface of providing an interactive media session, according to some embodiments.

FIG. 4G illustrates a seventh example user interface of providing an interactive media session, according to some embodiments.

FIG. 5 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing interactive supplemental content such as, but not limited to, advertisements.

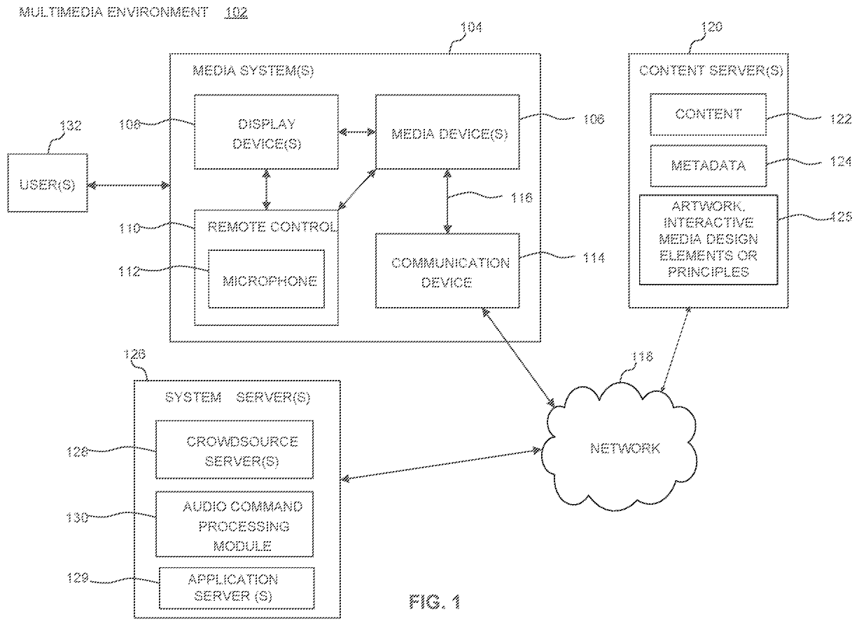

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, smartwatch, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form. Each content server 120 may also store, but not limited to, artwork, interactive media design elements or principles 125 associated with content 122 and/or metadata 124.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128. The crowdsource server(s) 128 can include big data backend type of systems. The crowdsource server(s) 128 can crowdsource data from various devices (e.g., other media devices 106) from crowd or different users. The crowdsource server(s) 128 can monitor the data from the crowd or different users and take appropriate actions.

In some examples, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

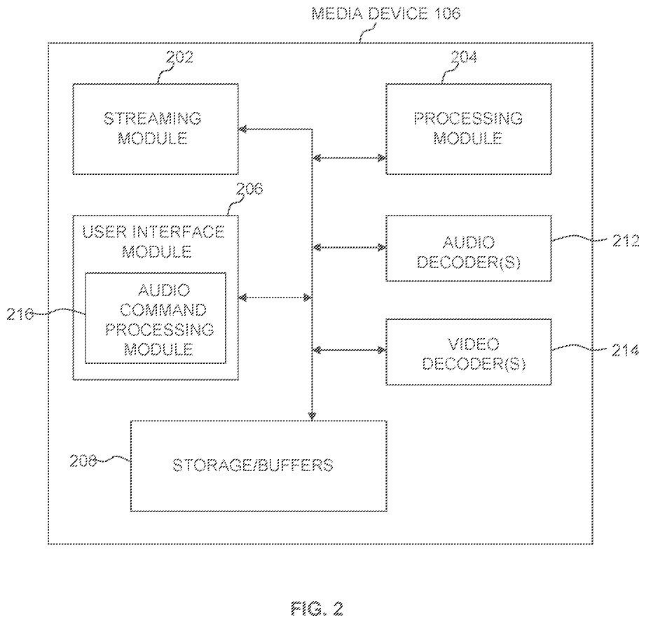

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

In some embodiments, the system servers 126 may include one or more application servers 129. One or more application servers 129 can include a digital distribution platform for one or more companion applications associated with media systems 104 and/or media devices 106. For example, user 312 may use the one or more companion applications to control media device 106 and/or display device 108. One or more application servers 129 can also manage login credentials and/or profile information corresponding to media systems 104 and/or media devices 106. The profile information may include names, usernames, and/or data corresponding to the content or media viewed by users 132.

In addition or alternatively, one or more application servers 129 may include or be part of a distributed client/server system that spans one or more networks, for example, a local area network (LAN), wide area network (WAN), the Internet, a cellular network, or a combination thereof connecting any number of mobile clients, fixed clients, and servers. In some aspects, communication between each client (e.g., user 132 or remote control 110) and server (e.g., one or more application servers 129) can occur via a virtual private network (VPN), Secure Shell (SSH) tunnel, or other secure network connection. One or more application servers 129 may also be separate from system servers 126, or in a different location than shown in FIG. 1, as will be understood by a person of ordinary skill in the art.

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmy, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Interactive Supplemental Content Platform

Serving supplemental content (e.g., advertisement content) in a display advertising ecosystem can often be a low engagement experience for users. This can often be the case with static advertisement content (e.g., traditional banner advertisement or advertisements on a screen saver application) displayed on a TV display. This is because a user may not view or focus on the static advertisement content when it is playing on the TV display. In addition, static advertisement content may not be relevant to the user.

To solve the above problems, embodiments and aspects herein involve an application server (e.g., application server 129) providing an interactive supplemental content platform. The application server can generate an interactive media session in an application associated with a media device (e.g., media device 106). The interactive media session can include interactive media content and interactive supplemental content. The application server can cause display, on a display device (e.g., display device 108) associated with the media device, the interactive media session. The application server can receive a user input, such as from user 132, to interact with the interactive supplemental content in the interactive media session. In response to the user input, the application server can generate a reward in the interactive media session.

Embodiments and aspects herein can make the advertisement viewing experience fun by engaging and incentivizing the user. The interactive media session, such as a game session, can act as an advertisement platform. In the interactive media session, different or new advertisement types can be provided to the user. Different or new advertisement types can include game scratcher ads, interactive video advertisements with rewards, game characters, rewards or virtual points, and/or display background in the interactive media session. The user may be incentivized to engage with the different advertisements types in the interactive media session.

According to some aspects, a remote control (e.g., remote control 110) can be used to interact with an interactive media session. Referring to FIG. 1, a user 132 may control (e.g., navigate through available content, select content, play or pause multimedia content, fast forward or rewind multimedia content, switch to a different channel, adjust the volume or brightness of display device 108, etc.) the media device 106 and/or display device 108 using remote control 110. Remote control 110 can be any component, part, apparatus and/or method for controlling the media device 106 and/or display device 108, such as a remote control with physical buttons, a tablet, laptop computer, smartphone, smart device, smartwatch, wearable, on-screen controls, integrated control buttons, audio controls, or any combination thereof, to name just a few examples. In some aspects, the remote control 110 can wirelessly communicate with the media device 106 and/or display device 108 using WiFi, Bluetooth, cellular, infrared, etc., or any combination thereof. The remote control 110 may include a microphone 112. In some aspects, remote control 110 may supply a command to media device 106 via user interface module 206. This command may be provided via menu selections displayed on remote control 110. In some aspects, user 132 may press arrow keys on a remote control with physical buttons, to control media device 106 and/or display device 108.

In some aspects, remote control 110 can include a companion application on an electronic device associated with user 132, using for example, a remote control feature, to control media device 106 and/or display device 108. A companion application can be a software application designed to run on smartphones, tablet computers, smart device, smartwatch, wearable, IoT device, desktop computers and/or other electronic devices. Typically, an electronic device can offer an array of applications, including a companion application, to a user. These applications may be free or purchased through an application store and installed at the user's electronic device. The companion application can be a software application that runs on a different device than the primary intended or main application, for example, on media device 106. The companion application can provide content that is similar to the primary user experience but could be a subset of it, having fewer features and being portable in nature. For example, user 132 may use selections on a user interface on remote control 110, such as a companion application on an electronic device, to control media device 106 and/or display device 108. User 132 may use arrow keys or selections on the user interface on the companion application to navigate a grid of tiles, where each tile represents a channel associated with media device 106 and/or display device 108. User 132 may also use buttons or selections on the companion application to trigger an operation associated with media device 106 and/or display device 108. Accordingly, when remote control 110 is discussed herein, it should be understood that remote control 110 may be or may include any combination of a remote control with physical buttons and/or companion applications.

In addition, aspects herein can provide advertisements at a faster rate in an interactive media session than static advertisements (e.g., a traditional banner ad or a screensaver application associated with the media device or display device). Rewards associated with the interactive media session can be linked to an account that can offer real-world rewards to the user.

In the following discussion, application server 129 is described as performing various functions associated with providing an interactive supplemental content platform. However, system server 126, media device 106, display device 108, remote control 110, and/or another electronic device as would be appreciated by a person of ordinary skill in the art may perform one or more of the functions associated with providing an interactive supplemental content platform.

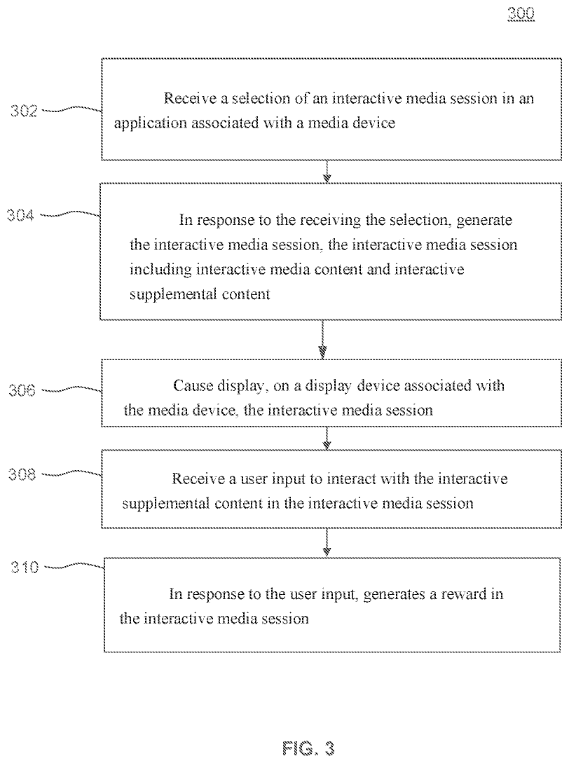

FIG. 3 illustrates a flowchart for a method 300 for providing interactive supplemental content, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Moreover, while the steps are described as being performed by application server 129, some or all of the steps may be performed by system server 126, media device 106, display device 108, remote control 110, or and/or another electronic device as would be appreciated by a person of ordinary skill in the art.

Method 300 shall be described with reference to FIGS. 1-2. However, method 300 is not limited to that example embodiment.

In 302, application server 129 receives a selection of an interactive media session in an application associated with media device 106. The application may be downloaded from application server 129. The application can include a screen saver application installed on media device 106. The screen saver application can display moving images or patterns on display device 108 when the media device 106 is not in use. The application can include any standalone application installed on media device 106, and not limited to a screen saver application. The interactive media session can include a session in the application that allows the user to control, combine, manipulate, and/or interact with different types of media, such as text, sound, video, computer graphics, and animation. The interactive media session can include for example, a game, virtual reality, a quiz, a survey, an interactive video, and/or animated infographics, or any type of material that encourages user participation.

According to some aspects, application server 129 can receive selection of an interactive media session from remote control 110 from user 132. Remote control 110 can include a remote control with physical buttons as described with reference to FIG. 1. Also or alternatively, application server 129 can receive selection of an interactive media session from multiple users 132, for example at approximately the same time. For example, multiple users 132 associated with the media device 106, such as in the same household, can select the interactive media session using multiple remote control 110 associated with media device 106. In another example, multiple users 132 associated with the media device 106, such as in the same household, can select the interactive media session using multiple remote control 110 associated with media device 106.

In some examples, prior to the receiving the selection of the interactive media session, application server 129 can cause the display, on display device 108 associated with media device 106, of an indication to select the interactive media session in the application. For example, the indication can include an indicator to play a game, such as, for example, an indicator in a user interface in the application to select by an arrow key or button on remote control 110. In some examples, remote control 110, such as a remote control with physical buttons, may include a microphone (e.g., microphone 112) for a user to provide a verbal command to provide a selection of an interactive media session on media device 106. For example, user 132 may provide an audio command, such as “play ABCD city game” to select the interactive media session on media device 106.

According to some aspects, remote control 110 can include a companion application on electronic device as described above. In some aspects, a user can navigate one or more menus or graphical user interfaces (GUI) displayed on the companion application to provide a selection. The electronic device can also include a microphone for a user to provide a verbal command to provide a selection. In some examples, application server 129 or media device 106 can receive a user input, such as from a GUI or microphone, on the electronic device to select an interactive media session on media device 106. For example, user 132 can provide an audio command using the companion application, such as “play ABCD city game”, to select an interactive media session on media device 106.

According to some aspects, and still discussing 302, application server 129 can receive a selection of an interactive media session from media device 106. In some examples, media device 106 can also include a microphone for a user to provide a verbal command to provide a selection. In some examples, application server 129 can receive a user input, such as from user interface module 206, to select an interactive media session on media device 106.

According to some aspects, application server 129 can receive a selection of an interactive media session on media device 106 from a smart device and/or an IoT device associated with media device 106. For example, the smart device and/or the IoT device can include a smart speaker, such as a Wi-Fi-enabled speaker with voice assistants. The smart device and/or the IoT device can be controlled using a voice of a user. In some examples, application server 129 can receive a user input, such as from a microphone, on the smart device and/or the IoT device to select an interactive media session on media device 106. For example, user 132 may provide an audio command, such as “play ABCD city game,” to a smart speaker to an interactive media session on media device 106.

In 304, in response to the receiving the selection, application server 129 generates the interactive media session. The interactive media session can include interactive media content and interactive supplemental content. The interactive media content can include a character, a reward and/or a display background associated with the interactive media session. For example, the interactive media session can include a game. In some aspects, the interactive media content can include a game character (e.g., fictional character), and a display background or theme displayed in the game. The reward can include an offer, a virtual point, a coin, a QR code, a discount code or coupon, which can be linked to an account that can offer real-world rewards to the user.

The interactive supplemental content can include interactive advertisement content, (e.g., game scratcher ads, interactive video advertisements with rewards), informational messages, social media posts, game characters, rewards or virtual points, and/or display background in the interactive media session. The interactive media content may be associated with the interactive supplemental content based at least on contextual information. For example, interactive media session can include a game, and interactive media content can include game content generated based on artwork, interactive media design elements, or principles 125. The interactive media content can include a character, a reward, and/or a display background associated with the game. The interactive media content, such as a character, a reward, and/or a display background may be associated with the interactive supplemental content based at least on contextual information.

According to some aspects, particularly, in 304, application server 129 identifies a characteristic of user 132 based on the selection of the interactive media session. A characteristic of user 132 may include age, physical disability, left or right handedness, or other characteristic pertinent to operation of remote control 110, and/or media device 106 as would be appreciated by persons skilled in the art. Application server 129 may identify a characteristic of user 132 based on the currently logged in user profile to media device 106. Also or alternatively, application server 129 may identify a characteristic of user 132 based on remote control 110. In some aspects, remote control 110 may include a camera, and/or an accelerometer or other motion-sensing module (not shown in FIG. 1). Remote control 110 may capture and process an image of user 132 operating remote control 110 to identify user 132. Additionally, remote control 110 may include a well-known sensor (not shown) for voice identification. Application server 129, media device 106 and/or system server 126 may recognize user 132 via his or her voice in a well-known manner, when user 132 speaks into microphone 112 of remote control 110 or a connected IoT device. These and additional techniques and approaches for identifying a characteristic of user 132 are within the scope and spirit of this disclosure, as will be apparent to persons skilled in the relevant arts based on the herein teachings.

According to some aspects, in 304, application server 129 can generate the interactive media content or the interactive supplemental content based on the characteristic of the user. For example, application server 129 can generate the interactive media content or the interactive supplemental content appropriate or relevant to a child based on the characteristic of the user as a child.

According to some aspects, application server 129 may generate the interactive media content or the interactive supplemental content using a machine learning mechanism. System servers 126 or media device 106 may perform a machine learning based on content data, historical watch data, user data, and various other data as would be appreciated by a person of ordinary skill in the art. System server 126 may perform the machine learning by crowdsourcing data from various devices (e.g., other media devices 106).

As described above, application server 129 can receive the selection of the interactive media session from multiple users 132. In response to the receiving the selection, application server 129 can generate the interactive media session in a multi-user mode. For example, multiple users 132 in a household can interact with the interactive media session, such as by using multiple remote controls 110.

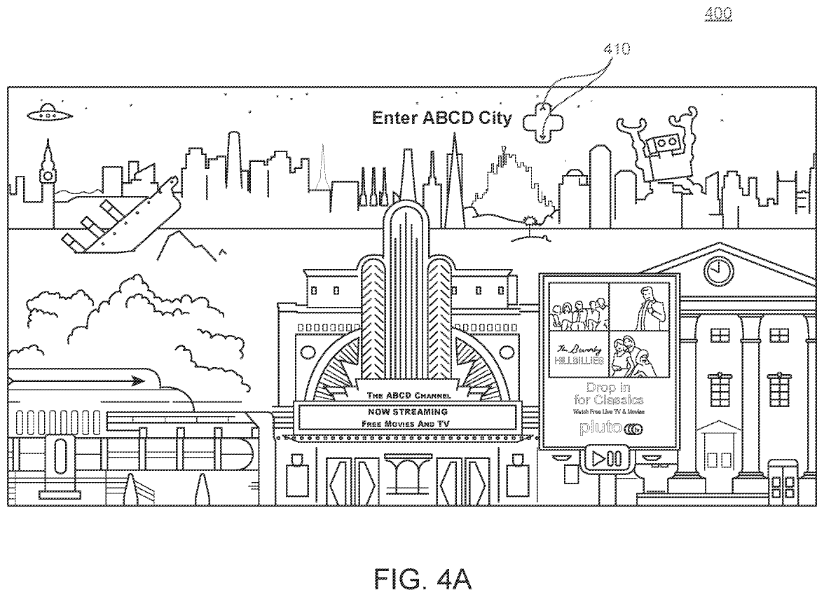

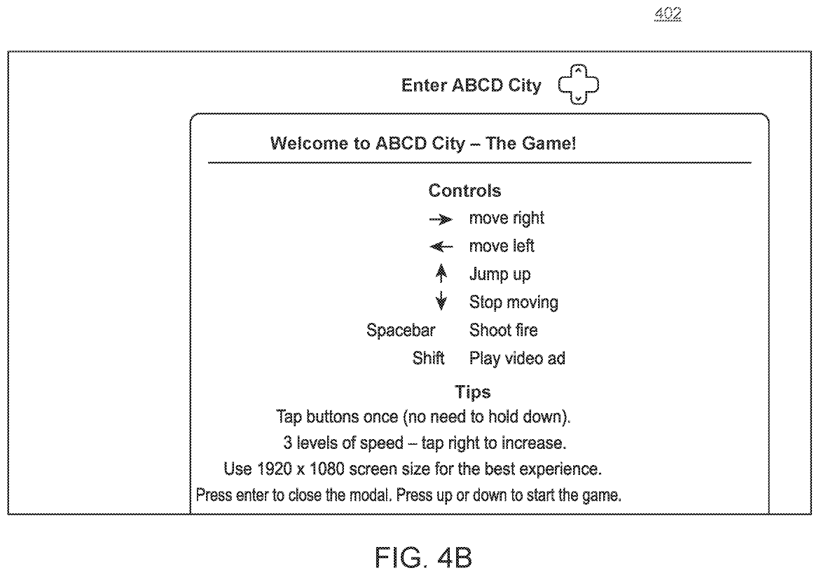

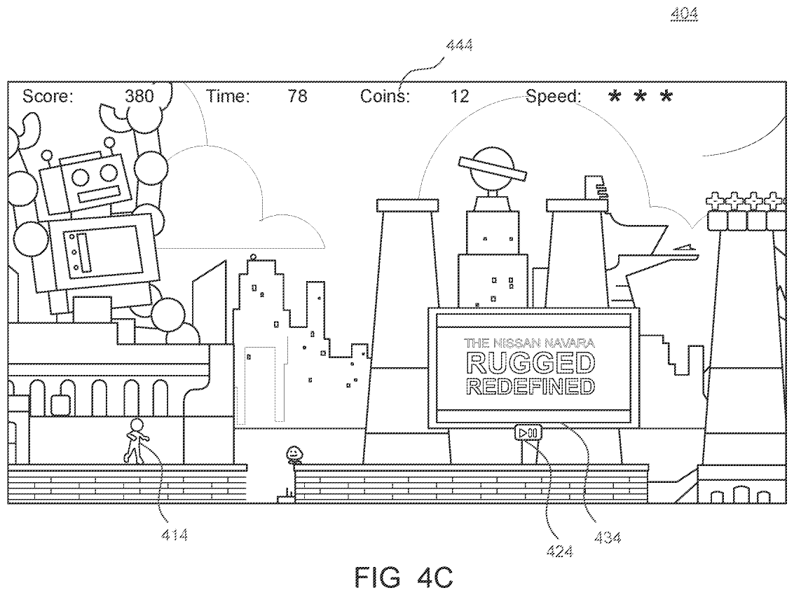

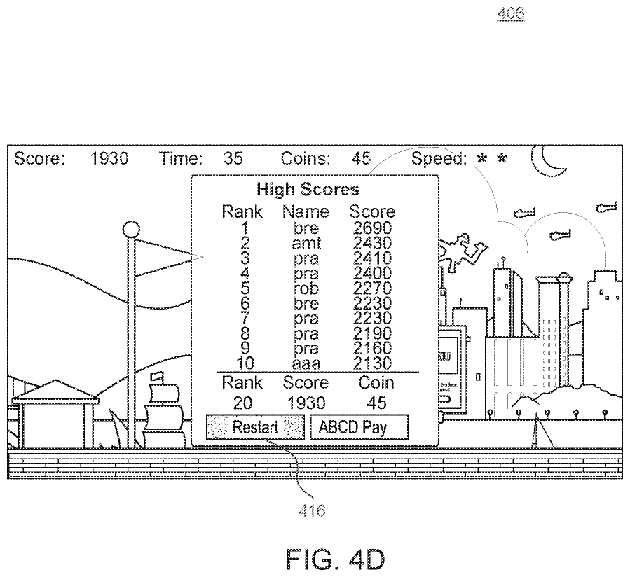

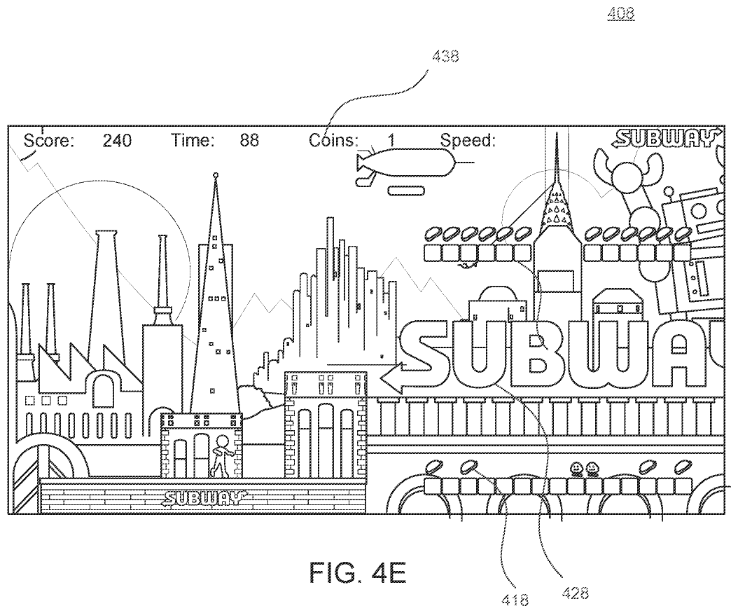

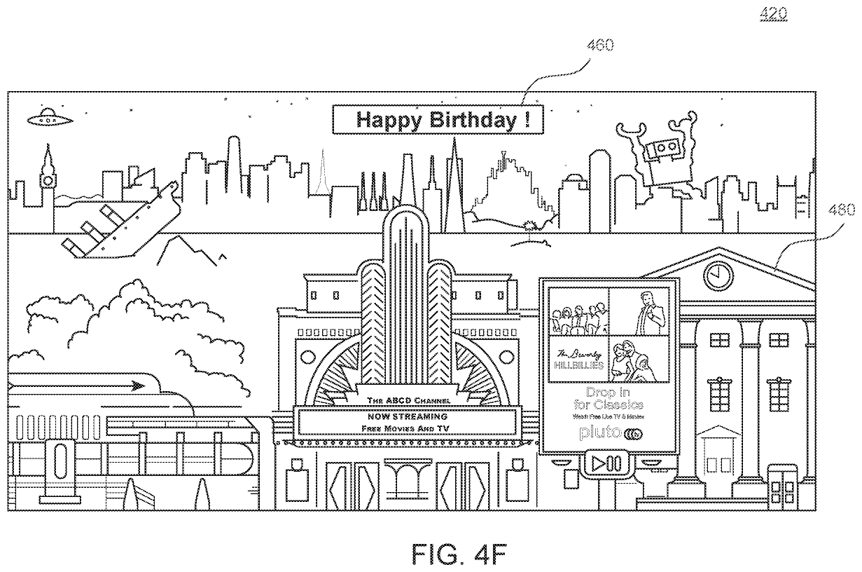

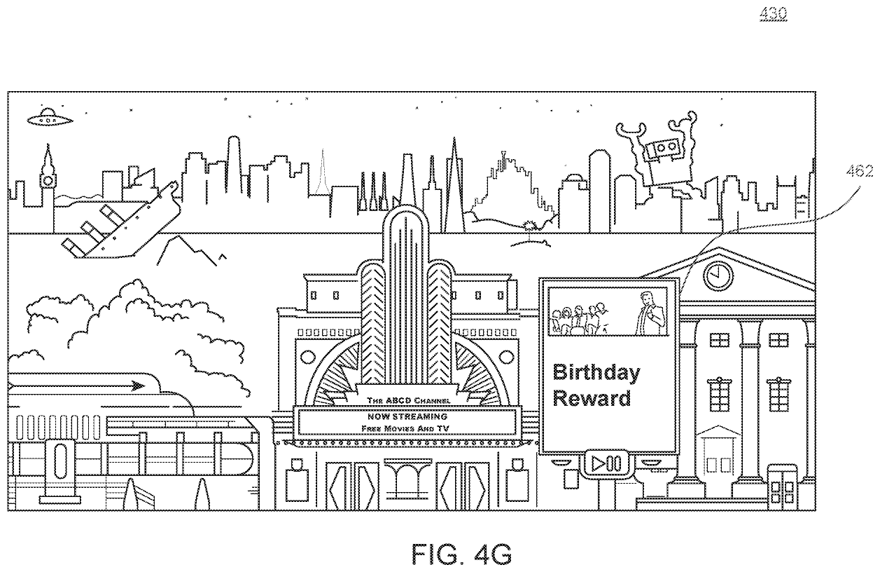

In 306, application server 129 causes display, on display device 108 associated with media device 106, of the interactive media session. Application server 129 can cause display, on a user interface of the application displayed on display device 108, one or more instructions on how to interact with the interactive media session, such as using remote control 110. Application server 129 can cause display, on the user interface of the application displayed on display device 108, the interactive media content, the interactive supplemental content. Exemplary user interfaces of the interactive media session in the application will be discussed with reference to FIGS. 4B-4G.

According to some aspects, application server 129 may modify the user interface of the application during the interactive media session, based on a user input or a progress of the interactive media session.

As described above, in response to the receiving the selection, application server 129 can generate the interactive media session in a multi-user mode. Application server 129 can cause display, the multi-user mode on display device 108 associated with media device 106, of the interactive media session. For example, application server 129 can cause display, two user interfaces adjacent to each other in the horizontal direction on display device 108 for two users 132 in the interactive media session. User 132 can interact with one of the two user interfaces on the left hand side on the display device 108. Another user can interact with the remaining one of the two user interfaces on the right hand side on the display device 108 132 in the interactive media session.

In 308, application server 129 receives a user input to interact with the interactive supplemental content in the interactive media session.

As described above, application server 129 can receive a user input from one or more physical buttons and/or GUIs displayed on the remote control 110. Also or alternatively, application server 129 can receive a user input from motion data associated with remote control 110. Remote control 110 may be configured to detect its motion (e.g., a change in orientation, position, location, angular velocity, rotation, etc.). For example, remote control 110 may include one or more motion sensors (e.g., a gyroscope, an accelerometer, etc.) that detect changes of motion of remote control 110. Remote control 110 may use the one or more motion sensors to obtain motion data describing the changes of motion of remote control 110. In other words, remote control 110 may be configured to perform motion sampling using the one or more motion sensors. Remote control 110 may be configured to provide the motion data to media device 106 for processing. For example, remote control 110 may be configured to transmit the motion data wirelessly to media device 106 for processing.

Also or alternatively, application server 129 can receive a user input from an audio command from a microphone on remote control 110, media device 106, a smart device, and/or an IoT device associated with media device 106. For example, application server 129 can receive an audio command of “shoot” to interact with the interactive supplemental content in a gun shooting game session.

According to some aspects, system servers 126 may include an audio command processing module 130. Remote control 110 or a connected smart device or IoT device may include a microphone 112. The microphone 112 may receive audio data from users 132 (as well as other sources, such as the display device 108). In some aspects, media device 106 may be audio responsive, and the audio data may represent verbal commands from the user 132 to control the media device 106 as well as other components in the media system 104, such as the display device 108. In some aspects, the audio data received by the microphone 112 in the remote control 110 can be transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing. In some aspects, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

According to some aspects, application server 129 can receive the user input to interact with the interactive media content. For example, application server 129 can receive a user input to interact with interactive supplemental content based on a user input to interact with a character, a reward and/or a display background associated with the interactive media session.

As described above, in response to the receiving the selection, application server 129 can generate the interactive media session in a multi-user mode. Application server 129 can receives user inputs from multiple users to interact with the interactive supplemental content in the interactive media session.

In 310, in response to the receiving the user input, application server 129 generates a reward in the interactive media session. The reward can include an offer, a virtual point, a coin, a QR code, a discount code or coupon, which can be linked to an account that can offer real-world rewards to the user. For example, the reward can include a discount of a brand associated with the interactive supplemental content. In another example, the reward can include an offer of a free rental of a movie or limited advertisement viewing experience on media device 106.

FIG. 4A illustrates a first example user interface for providing an interactive media session, according to some embodiments. An application on a media device (e.g., media device 106) may output user interface 400. For example, user interface 400 may provide an interactive media session in an application associated with media device 106 and/or display device 108. User interface 400 may be provided in association with a server (e.g., application server 129 of FIG. 1, as described above) that can be a digital distribution platform for applications. However, user interface 400 is not limited thereto.

User interface 400 includes various user interface elements 410 to provide an interactive media session in an application (e.g., screen saver application) on media device 106. As will be appreciated by persons skilled in the relevant arts, user interface elements 410 may be used to navigate through menus displayed on the display device 108, change settings of the display device 108 and/or the media device 106, etc. User interface elements 410 may include an indication to select an interactive media session in the application. For example, the indication can include an indicator to play or enter a game “ABCD City”, by selecting an arrow key or button on remote control 110.

User 132 may perform a user interaction with user interface 400 to select an interactive media session on media device 106 and/or display device 108. User interaction with user interface 400 may include tapping on (e.g., via touch input or stylus input), clicking (e.g., via mouse), scrolling, motion, audio command, and/or other methods as would be appreciated by a person of ordinary skill in the art.

User interface 400 may also be displayed as different shapes, colors, and sizes. Additionally, user interface 400 may have less user interface elements 410 or more user interface elements 410 than depicted in FIG. 4A. In some aspects, despite having different shapes, colors, sizes, etc., user interface 400 has the same or substantially the functionality. That is, user interface 400 may enable user 132 to interact with media device 106 and/or display device 108 as discussed herein.

FIG. 4B illustrates a second example user interface of providing an interactive media session, according to some aspects. FIG. 4C illustrates a third example user interface of providing an interactive media session, according to some aspects. FIG. 4D is illustrates a fourth example user interface of providing an interactive media session, according to some aspects. An application on a media device (e.g., media device 106) may output user interface 402, 404 and/or 406. For example, user interface 402, 404 and/or 406 may provide an interactive media session in an application associated with media device 106 and/or display device 108. User interface 402, 404 and/or 406 may be provided in association with a server (e.g., application server 129 of FIG. 1, as described above) that can be a digital distribution platform for applications. However, user interface 402, 404 and/or 406 is not limited thereto.

As described above, in response to the receiving the selection on user interface 400, application server 129 generates the interactive media session. As shown in FIG. 4B, prior to a start of the interactive media session, user interface 402 may be displayed to provide instructions to user 132 on how to interact with the interactive media session by using remote control 110.

As shown in FIG. 4C, user interface 404 may be displayed after the start of the interactive media session, such as based on a selection to start by a user. User interface 404 includes interactive media content 414, a user interface element 424, an interactive advertisement 434, and a reward 444. The interactive media content 414 can include a character of the game “ABCD City”. A user input to select the user interface element 424 may be provided by the user to interact with the interactive advertisement 434. For example, the user may select the user interface element 424 by remote control 110 to play the interactive advertisement 434. Also or alternatively, a user input to interact with the interactive media content 414 may be provided by the user to interact with the interactive advertisement 434. For example, the user may move the character of interactive media content 414 to the proximity of the interactive advertisement 434 and stay in the proximity above a pre-determined threshold of time.

In response to the user input, reward 444, such as a virtual point may generated and displayed in the interactive media session. User interface 404 can include other elements, such as time speed, and/or score associated with the interactive media session as shown in FIG. 4C.

As shown in FIG. 4D, at the end of the interactive media session, user interface 406 displays different users who interacted with the interactive media session, rank and score associated with each user, and user interface element 416. User interface element 416 can be displayed for the user to select restarting the interactive media session.

FIG. 4E illustrates a fifth example user interface of providing an interactive media session, according to some embodiments. An application on a media device (e.g., media device 106) may output user interface 408. For example, user interface 408 may provide an interactive media session in an application associated with media device 106 and/or display device 108. User interface 408 may be provided in association with a server (e.g., application server 129 of FIG. 1, as described above) that can be a digital distribution platform for applications. However, user interface 408 is not limited thereto.

As described above, in response to the receiving the selection on user interface 400, application server 129 can generate the interactive media session as shown in FIG. 4B-4D. Also or alternatively, as shown in FIG. 4E, application server 129 can generate the interactive media session with interactive media content associated with a brand of an interactive advertisement (e.g., Subway). The interactive media content 418 and 428 may be generated based on at least on contextual information associated with the interactive advertisement. The interactive media content 418 can include an object associated with the interactive advertisement, such as in a shape of a sandwich. The interactive media content 428 can include a display background of the interactive media session associated with the interactive advertisement, such as in a shape of a brand logo.

In response to the user input on interactive media content 418 or 428, reward 438, such as a virtual point may generated and displayed in the interactive media session. User interface 408 can include other elements, such as time speed, and/or score associated with the interactive media session as shown in FIG. 4E.

According to some aspects, user interfaces 402, 404, 406 and/or 408 may have less user interface elements or more user interface elements than depicted in FIGS. 4B-4E. In some aspects, despite having different shapes, colors, sizes, etc., user interfaces 402, 404, 406 and/or 408 have the same or substantially the functionality. That is, user interfaces 402, 404, 406 and/or 408 may enable user 132 to interact with media device 106 and/or display device 108 as discussed herein.

FIG. 4F illustrates a sixth example user interface of providing an interactive media session, according to some embodiments. And FIG. 4G illustrates a seventh example user interface of providing an interactive media session, according to some embodiments. An application on a media device (e.g., media device 106) may output user interface 420 and/or 430. For example, user interface 420 and/or 430 may provide an interactive media session in an application associated with media device 106 and/or display device 108. User interface 420 and/or 430 may be provided in association with a server (e.g., application server 129 of FIG. 1, as described above) that can be a digital distribution platform for applications. However, user interface 420 and/or 430 are not limited thereto.

According to some aspects, an interactive media session in an application (e.g., a screen saver application) on media device 106 may be initiated by a user, such as a user different from user 132. The user may be based at a different geographic location than user 132, such as from different household. Also or alternatively, the user may be socially associated with user 132. For example, the user may be associated with user 132 in one or more social networking services, such as including different social groups of friends, coworkers, and family. The application server 129 may provide the user with an option to initiate an interactive media session, for example, via media device 106, display device 108, and/or a website or companion application associated with media device 106. The option may include different parameters to initiate the interactive media session. For example, the application server 129 may provide the user with an option to send a message (e.g., a “Happy Birthday” message) to user 132 in the application. Different parameters may include, but are not limited to, a payment method, identification information of a user receiving the interactive media session, media content, and/or supplemental content provided by the user.

According to some aspects, the user may select the option to send a message (e.g., “Happy Birthday” message) to user 132 in the application, by using media device 106, display device 108, and/or a website or companion application associated with media device 106. The user may provide identification information, including, but not limited to, email address, physical address, and/or name of user 132. The user may include one or more payment methods to initiate the interactive media session. The user may provide media content, such as an image or video to application server 129 to initiate the interactive media session. For example, the user may capture an image of his house or an image of himself. The user may provide supplemental content, such as reward, virtual points to system server 126 and/or application server 129 to send to user 132 to initiate the interactive media session.

According to some aspects, application server 129 may receive the selection of the interactive media session by the user in the application, such as to send a “Happy Birthday” message to user 132. In response to the receiving the selection, application server 129 may generate the interactive media session. The interactive media session may include interactive media content and interactive supplemental content. Application server 129 may generate the interactive media content and interactive supplemental content, based on the media content and/or supplemental content provided by the user. Application server 129 and/or system server 126 may perform image processing on the media content provided by the user, for example using artificial intelligence (AI) and augmented reality technologies. For example, system server 126 and/or application server 129 may apply an AI filter to the image provided by the user, for example, to change a color of the image. According to some aspects, prior to the generating the interactive media session, system server 126 and/or application server 129 may determine whether the user is socially associated with user 132. Upon determining that the user is not socially associated with user 132, application server 129 and/or system server 126 may perform image processing on the media content and/or supplemental content provided by the user, to identify or remove the media content and/or supplemental content that may be inappropriate to user 132.

The application server 129 may cause display, on display device 108 associated with media device 106, the interactive media session in user interfaces 420 and/or 430 as shown in FIG. 4F-4G. As shown in FIG. 4F, interactive media content 460 may include a “Happy Birthday” message or other type of message. Interactive media content 480 may include a display background of the application. Interactive media content 480 may be associated with an image provided by the user after image processing, such as an image of the house provided by the user.

User 132 may receive a notification, for example, by an email, or a message on media device 106 and/or display device 108, indicating the interactive media session. User 132 may perform a user interaction with interactive media content 460 or 480 in the interactive media session on media device 106 and/or display device 108. User interaction with user interface 420 may include pressing buttons on remote control 110, tapping on (e.g., via touch input or stylus input), clicking (e.g., via mouse), scrolling, motion, audio command, and/or other methods as would be appreciated by a person of ordinary skill in the art.

According to some aspects, upon receiving the user interaction with interactive media content 460, user interface 430 may be displayed. As shown in FIG. 4G, user interface 430 includes an interactive supplemental content 462. The interactive supplemental content 462 can include media content, website resources, informational messages, social media posts, and/or rewards or virtual points in the interactive media session. The interactive supplemental content 462 may be associated with the interactive media content based at least on contextual information. For example, upon receiving the user interaction with interactive media content 460 to select the “Happy Birthday” message, a video or music related to a Birthday theme may be displayed as the interactive supplemental content 462. Also or alternatively, an ecommerce website URL offering birthday presents may be displayed as the interactive supplemental content 462. Also or alternatively, the reward can include an offer, a virtual point, a gift card, a QR code, a discount code or coupon, which can be linked to an account that can offer real-world rewards to user 132. For example, the reward can include a gift card sent to user 132. In another example, the reward can include an offer of a free rental of a movie or limited advertisement viewing experience on media device 106.

According to some aspects, user 132 may interact with the user who initiate the interactive media session by interacting with the interactive supplemental content and/or interactive media content. Also or alternatively, user 132 may interact with the user in the interactive media session by one or more conversations, such as real-time conversations. In some aspects, application server 129, system server 126 or media device 106 may perform language processing based on the keywords or sentences in the conversations.

User interfaces 420 and/or 430 may also be displayed as different shapes, colors, and sizes. Additionally, user interfaces 420 and/or 430 may have less user interface elements or more user interface elements than depicted in FIGS. 4F and 4G. In some aspects, despite having different shapes, colors, sizes, etc., user interface 420 and/or 430 has the same or substantially the functionality. That is, user interface 420 and/or 430 may enable user 132 to interact with media device 106 and/or display device 108 as discussed herein.

### Example Computer System

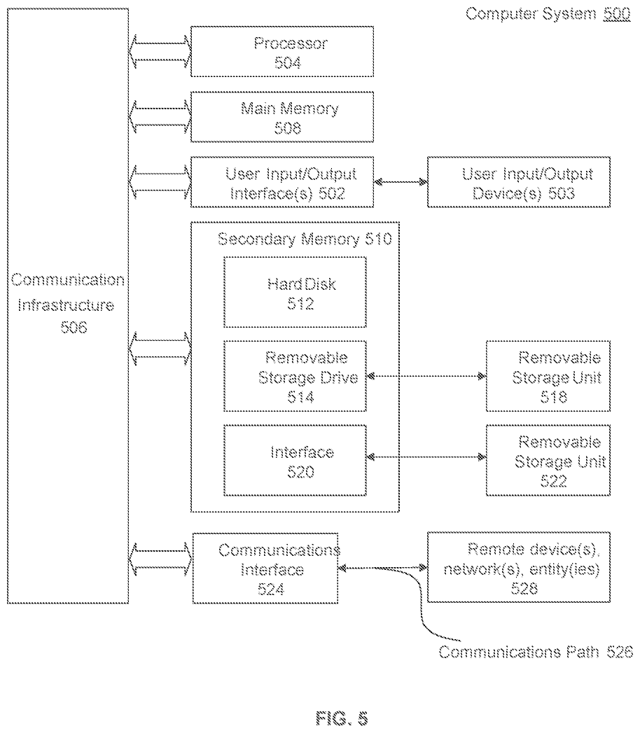

Various embodiments may be implemented, for example, using one or more well-known computer systems, such as computer system 500 shown in FIG. 5. For example, application server 129 may be implemented using combinations or sub-combinations of computer system 500. Also or alternatively, application server 129 may be implemented using combinations or sub-combinations of computer system 500. Also or alternatively, one or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for providing interactive supplemental content, comprising:
receiving, by at least one computer processor, a selection of an interactive media session in an application associated with a media device;
in response to the receiving the selection, generating the interactive media session, wherein the interactive media session comprises interactive media content and the interactive supplemental content;
causing display of, on a display device associated with the media device, the interactive media session;
receiving a user input to interact with the interactive supplemental content in the interactive media session; and
in response to receiving the user input, generating a reward in the interactive media session.

2. The computer-implemented method of claim 1, further comprising, prior to the receiving the selection of the interactive media session, causing display of, on the display device associated with the media device, an indication to select the interactive media session in the application.

3. The computer-implemented method of claim 1, wherein the interactive media content comprises a character, the reward, or a display background associated with the interactive media session.

4. The computer-implemented method of claim 1, wherein the generating the interactive media session comprises:
identifying a characteristic of a user based on the selection of the interactive media session; and
generating the interactive media content or the interactive supplemental content based on the characteristic of the user.

5. The computer-implemented method of claim 1, wherein the interactive media content is associated with the interactive supplemental content based at least on contextual information.

6. The computer-implemented method of claim 1, wherein the receiving the user input to interact with the interactive supplemental content in the interactive media session comprises:
receiving the user input to interact with the interactive media content.

7. The computer-implemented method of claim 1, wherein the receiving the user input to interact with the interactive supplemental content in the interactive media session comprises:
receiving the user input from a remote control associated with the media device, wherein the remote control comprises a tablet, a laptop computer, a smartphone, a smartwatch, smart device, or a wearable device.

8. A computing system for providing interactive supplemental content, comprising:
one or more memories; and
at least one processor each coupled to at least one of the memories and configured to perform operations comprising:
receiving a selection of an interactive media session in an application associated with a media device;
in response to the receiving the selection, generating the interactive media session, wherein the interactive media session comprises interactive media content and the interactive supplemental content;
causing display of, on a display device associated with the media device, the interactive media session;
receiving a user input to interact with the interactive supplemental content in the interactive media session; and
in response to receiving the user input, generating a reward in the interactive media session.

9. The computing system of claim 8, wherein the operations further comprise: prior to the operation of receiving the selection of the interactive media session, causing display, on the display device associated with the media device, an indication to select the interactive media session in the application.

10. The computing system of claim 8, wherein the interactive media content comprises a character, the reward or a display background associated with the interactive media session.

11. The computing system of claim 8, wherein the operation of the generating the interactive media session comprises:
identifying a characteristic of a user based on the selection of the interactive media session; and
generating the interactive media content or the interactive supplemental content based on the characteristic of the user.

12. The computing system of claim 8, wherein the interactive media content is associated with the interactive supplemental content based at least on contextual information.

13. The computing system of claim 8, wherein the operation of the receiving the user input to interact with the interactive supplemental content in the interactive media session comprises:
receiving the user input to interact with the interactive media content.

14. The computing system of claim 8, wherein the operation of the receiving the user input to interact with the interactive supplemental content in the interactive media session comprises:
receiving the user input from a remote control associated with the media device, wherein the remote control comprises a tablet, a laptop computer, a smartphone, a smartwatch, a smart device or a wearable device.

15. A non-transitory computer-readable medium having instructions stored thereon that, when executed by at least one computing device, cause the at least one computing device to perform operations comprising:
receiving a selection of an interactive media session in an application associated with a media device,
in response to the receiving the selection, generating the interactive media session, wherein the interactive media session comprises interactive media content and interactive supplemental content;
causing display of, on a display device associated with the media device, the interactive media session;
receiving a user input to interact with the interactive supplemental content in the interactive media session; and
in response to receiving the user input, generating a reward in the interactive media session.

16. The non-transitory computer-readable medium of claim 15, wherein the operations further comprise, prior to the operation of receiving the selection of the interactive media session, causing display of, on the display device associated with the media device, an indication to select the interactive media session in the application.

17. The non-transitory computer-readable medium of claim 15, wherein the interactive media content comprises a character, the reward or a display background associated with the interactive media session.

18. The non-transitory computer-readable medium of claim 15, wherein the operation of the generating the interactive media session comprises;
identifying a characteristic of a user based on the selection of the interactive media session; and
generating the interactive media content or the interactive supplemental content based on the characteristic of the user.

19. The non-transitory computer-readable medium of claim 15, wherein the interactive media content is associated with the interactive supplemental content based at least on contextual information.

20. The non-transitory computer-readable medium of claim 15, wherein the operation of the receiving the user input to interact with the interactive supplemental content in the interactive media session comprises receiving the user input to interact with the interactive media content.
